(19) United States
(12) Patent Application Publication
(10) Pub. No.: US 2008/0152136 A1
(43) Pub. Date: Jun. 26, 2008

(54) DRIVING RECORDER, DRIVING RECORDER SYSTEM AND RECORDING AND REPRODUCING METHOD FOR DRIVING RECORDER SYSTEM

(75) Inventor: Yutaka Kashihara, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 11/960,622

(22) Filed: Dec. 19, 2007

(30) Foreign Application Priority Data
Dec. 26, 2006 (JP) 2006/350276

(51) Int. Cl. H04N 7/167

(52) U.S. Cl. 380/200

(57) ABSTRACT

A driving recorder system, which enables realizing easy-to-use handling of recorded data, excellent impact resistance and high security with no superfluous operations, includes a driving recorder for recording vehicle driving information and a reproducing apparatus for reproducing the vehicle driving information recorded in the driving recorder. The driving recorder has an encryption apparatus for encrypting the vehicle driving information by using a public key, and a first optical disc apparatus for continuously recording the vehicle driving information encrypted thereby into an optical disc. The reproducing apparatus has a second optical disc for reproducing the vehicle driving information recorded in the optical disc, and a decryption apparatus for decrypting the vehicle driving information reproduced thereby by using a secret key corresponding to the public key. It is featured that the encryption apparatus performs encrypting by using a public key recorded in the optical disc in advance.

### CROSS-REFERENCE TO RELATED APPLICATIONS

This application claims the benefit of priority of Japanese Patent Application No. 2006-350276, filed Dec. 26, 2006, the entire contents of which are incorporated herein by reference.

### BACKGROUND

1. Field

The present invention relates to a driving recorder, a driving recorder system and a recording and reproducing method for a driving recorder system, and more particularly, to a driving recorder, a driving recorder system and a recording and reproducing method for a driving recorder system which record vehicle operating information and images of a vehicle's surroundings and so forth.

2. Description of the Related Art

Recently, driving recorders, which are mounted in vehicles such as an automobile, have become widespread. Such a driving recorder is an apparatus in which, in a case where an automobile accident or the like occurs, so that a thorough investigation of the cause of the occurrence can be made, there are recorded vehicle driving conditions and so forth, including those at the time of accident occurrence.

As a driving recorder, for example, there is known an apparatus in which, a vehicle speed, an acceleration, a brake pressure, a steering angle and so forth are detected by various vehicle sensors mounted in a vehicle, and along with it, images of the vehicle's surroundings are taken by an in-vehicle camera, and then, information outputted from the various vehicle sensors and the images of the vehicle's surroundings are recorded.

As a recording medium, there is mostly used a nonvolatile memory such as a flash memory. In this case, as there is a limit in a recording capacity, there is mostly used a form in which latest information is constantly overwritten, or a form in which a time of an accident is detected from information of various vehicle sensors, and then, information during a period of time before and after the detected time.

Besides this, there is also an apparatus which is formed so that an HDD is mounted in the driving recorder and images of the vehicle's surroundings and so forth are continuously recorded for a long time.

On the other hand, regarding the driving recorder, there is also needed a security technology, for example, for preventing a falsification of recorded data made by parties involved in the accident, or preventing leaking of accident information to a third party. For example, in JP-A 2004-338607, there is disclosed a technology for encrypting recorded information in the driving recorder.

According to the technology disclosed by JP-A 2004-338607, it is made so that a public key and a secret key are published in association with a vehicle index number by a management center, and the public key is stored in an electronic number plate which is an object different from the driving recorder. Such an electronic number plate is distributed and installed in every vehicle. A public key stored in an electronic plate number is transferred to a driving recorder, and driving condition information and so forth are encrypted by this public key and recorded into the driving recorder. On the other hand, when reading out recorded data, it is performed by connecting a reading-out apparatus to the driving recorder via a cable and so forth. At this time, the reading-out apparatus receives a secret key transferred from the management center and decrypts the recorded data using this secret key.

Supposing a case where a recording medium of the driving recorder is a flash memory or a hard disk, it is necessary to transfer data recorded therein to other recording media.

For example, when an accident occurs involving a vehicle, such as a bus, a truck and a taxi, having a driving recorder mounted therein, a thorough investigation and so forth of the cause of the accident is made by a vehicle company, such as a truck company, a transportation company and a taxi company (in the following, which are called as just a company), on the basis of the data recorded in the driving recorder.

On this occasion, in a case where the recording medium is, for example, a flash memory, there is adopted a procedure of bringing the flash memory to the company, transferring data to a recording medium of a personal computer at the company, and then, loading the flash memory again into the data recorder of the vehicle. In general, flash memories are high in price, so that a way of being used in which they are repeatedly used is employed, however, in this case, it follows that data transferring is essentially needed.

In addition, in a case where the recording medium of the driving recorder is a hard disk, it follows that there is needed an operation of removing the HDD or the driving recorder itself from the vehicle, bringing it to the company, and there, connecting it to a personal computer at the company via a cable and transferring the recorded data thereto.

Moreover, in a case where the recording medium is a hard disk, it follows that it becomes difficult to read out the data recorded in the hard disk when the HDD apparatus becomes damaged or destroyed due to an accident impact.

As described above, in case of the flash memory and the hard disk and so forth which, conventionally, have been mostly used as a recording medium for the driving recorder, transferring the data into other recording media is needed, so that it is inconvenient to handle the recorded data. In addition, in case of using the hard disk as a recording medium, it is highly likely to become impossible to read out the recorded data due to a damage of the HDD apparatus in the event of an accident.

On the other hand, regarding the security technology, in the technology disclosed in JP-A 2004-338607, since it is made so that the public key and the driving recorder are objects different from each other, there is needed an operation of transferring the public key into an electronic number plate, so that there is some inconvenience in handling. Additionally, it is not suitable to apply the technology to small-size taxi companies and so forth, because an entire system, including facilities and the reading-out apparatus at the management center, is increased in size.

### SUMMARY OF THE INVENTION

The present invention is derived from observing the above-described circumstances, and has an object of providing a driving recorder, a driving recorder system and a recording and reproducing method for a driving recorder system which enable realization of high security with no superfluous operations, along with easy-to-use handling of recorded data and excellent impact resistance.

In order to solve the above-described problems, as described in a first aspect of the present invention, the driving recorder according to the present invention includes an encryption apparatus for encrypting vehicle driving information using a public key and an optical disc apparatus for continuously recording the vehicle driving information encrypted thereby into an optical disc, and further, it is featured that the encryption apparatus performs encrypting by using a public key recorded in the optical disc in advance.

Moreover, in order to solve the above-described problems, as described in a fourth aspect of the present invention, the driving recorder system according to the present invention includes a driving recorder for recording vehicle driving information and a reproducing apparatus for reproducing the vehicle driving information recorded in the driving recorder; the driving recorder has an encryption apparatus for encrypting the vehicle driving information using a public key and a first optical disc apparatus for continuously recording the vehicle driving information encrypted thereby into an optical disc; the reproducing apparatus has a second optical disc for reproducing the vehicle driving information recorded in the optical disc and a decryption apparatus for decrypting the vehicle driving information reproduced thereby using a secret key corresponding to the public key; and further, it is featured that the encryption apparatus of the driving recorder performs encrypting by using a public key recorded in the optical disc in advance.

Furthermore, in order to solve the above-described problems, as described in a seventh aspect of the present invention, a recording and reproducing method for the driving recorder system according to the present invention includes a step for encrypting vehicle driving information using a public key, a step for continuously recording the vehicle driving information encrypted thereby into an optical disc, a step for reproducing the vehicle driving information recorded in the optical disc, and a step for decrypting the vehicle driving information reproduced thereby by a secret key corresponding to the public key, and further, it is featured that, in the step for encrypting, the encryption is performed by using a public key recorded in the optical disc in advance.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a configuration example of an embodiment of the driving recorder system according to the present invention;

FIG. 2 is a flowchart showing an example of a sequence for recording a public key involving the reproducing apparatus;

FIG. 3 is a flowchart showing an example of a sequence for recording vehicle driving information involving the driving recorder;

FIG. 4 is a flowchart showing an example of a sequence for reproducing information from an optical disc involving the reproducing apparatus; and

FIG. 5 is a flowchart showing an example of a sequence for reading out information from a flash memory involving the reproducing apparatus.

### DETAILED DESCRIPTION

An explanation of an embodiment of the driving recorder, the driving recorder system and the recording and reproducing method for the driving recorder system with reference to accompanying drawings will be given.

### 1. Configuration of the Driving Recorder System

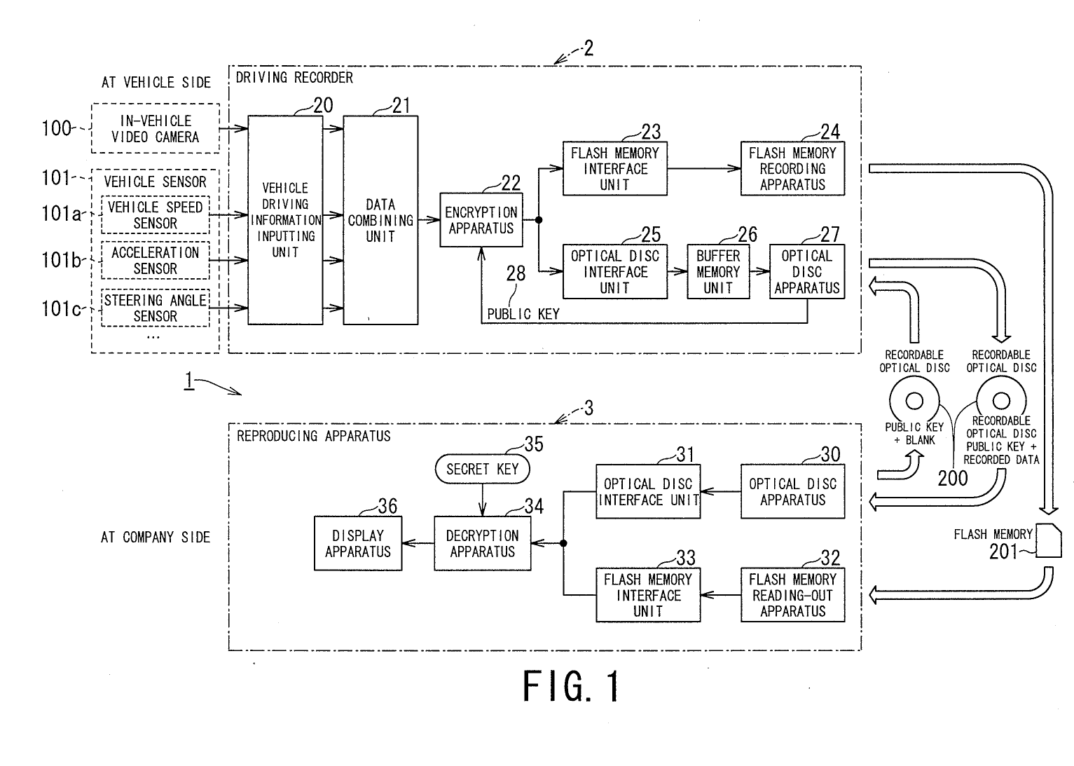

FIG. 1 is a block diagram showing an example of configuration of a driving recorder system 1 according to an embodiment of the present invention. The driving recorder system 1 is configured so as to include a driver recorder 2 and a reproducing apparatus 3.

The driving recorder 2 is an apparatus which is mounted in vehicles such as buses, trucks or taxies, and in a case where a vehicle accident or the like occurs, it is a main object thereof to record the accident conditions therefore, in the vehicle, there are mounted an in-vehicle video camera 100 for taking images of the vehicle's surroundings and a vehicle sensor 101, and the driving recorder 2 records image data outputted from the in-vehicle video camera 100 and vehicle sensor information outputted from the vehicle sensor 101. The vehicle sensor 101 is one which is composed of sensors for detecting various vehicle driving conditions, such as a vehicle speed sensor 101a, an acceleration sensor 101b and a steering angle sensor 101c.

A kind and a number of the in-vehicle video camera 100 and vehicle sensor 101 are not specifically limited, and it is allowed to be formed so that the driving recorder 2 records only image data or only vehicle sensor information.

In the driving recorder 2 according to the present embodiment, it is featured that the image data and the vehicle sensor information (which, in the following, are generically named as vehicle driving information) are continuously recorded into the optical disc 200. Here, the term ‘continuous recording’ refers to not recording for a period of time before and after the occurrence of the accident, but to continuously recording the vehicle driving information all the time the vehicle is being driven. In addition, a nonvolatile memory such as a flash memory 201 may be used for a continuous recording concurrently with the optical disc 200.

On the other hand, a reproducing apparatus 3 is an apparatus for reproducing information from the optical disc 200 and the flash memory 201 in which the vehicle driving information is recorded. The reproducing apparatus 3 is generally installed at operating companies for vehicles such as buses, trucks or taxies, and there, the reproduced vehicle driving information is analyzed and a thorough investigation of the cause of accident and so forth is made.

Next, there will be given an explanation of a detailed configuration of the driving recorder 2 and the reproducing apparatus 3.

The driving recorder 2 is configured so as to include a vehicle driving information inputting unit 20, a data combining unit 21, an encryption unit 22, a flash memory interface unit 23, a flash memory recording apparatus 24, an optical disc interface unit 25, a buffer memory unit 26 and an optical disc apparatus (a first optical disc apparatus) 27.

The vehicle driving information inputting unit 20 functions as an interface with the in-vehicle video camera 100 and various vehicle sensors, and vehicle sensor information such as image data, vehicle speed data and acceleration data are inputted thereinto.

In the data combining unit 21, image data and vehicle sensor information are multiplexed, and multiplexed vehicle driving information is produced.

The multiplexed vehicle driving information is encrypted by the encryption apparatus 22. An encryption key used here is one which is produced by the reproducing apparatus 3 at the company side. The reproducing apparatus 3 at the company side produces a secret key 35 and a public key 28 in a pair, and records the public key 28 thereof into an unused-state optical disc 200 which is distributed to a vehicle. The driving recorder 2 reproduces information from the optical disc 200 to obtain the public key 28, and the encryption apparatus 22 encrypts the vehicle driving information by using this public key 28.

As an optical disc 200 distributed to a vehicle from the company, a recordable optical disc capable of one-time recording (i.e., a write-once optical disc), such as an HD DVD-R, is preferable. By recording the public key 28 into the recordable optical disc 200, the public key 28 is prevented from being falsified.

The encrypted vehicle driving information is temporarily stored into the buffer memory unit 26 via the optical disc interface unit 25. Subsequently, it is outputted to the optical disc apparatus 27, and is recorded into the optical disc 200.

In the case of recording data into the optical disc 200, it is expected that writing errors possibly occur due to a vibration caused while the vehicle is being driven. Thus, it is formed so as to allocate the buffer memory unit 26 at a front stage of the optical disc apparatus 27. When the writing errors occur, the data stored in the buffer memory unit 26 is inputted once again and is rewritten into the optical disc 200, and thereby, a loss of the vehicle driving information can be kept to a minimum even when the writing errors occur due to the vibration.

In a case where a vehicle is significantly damaged due to a crash accident or the like, it is expected that the optical disc apparatus 27 itself possibly becomes damaged. According to the present embodiment, since the optical disc apparatus 27 is formed so as to constantly record the vehicle driving information into the optical disc 200 while the vehicle is being driven, if there is excluded a particular exception in which the optical disc 200 itself becomes destroyed or burnt out, even though the optical disc apparatus 27 becomes damaged, the data, which has been recorded until just before it has become damaged, remains as it is recorded in the optical disc 200, and thereby, the loss of important vehicle driving information at the time of accident can be avoided.

This point is significantly different from in case of the conventional driving recorder using an HDD. In general, once the HDD becomes damaged, even if the recorded data remains in the hard disk (magnetic disk) in an inside thereof, it is impossible to read out the data. Thus, the driving recorder having the HDD mounted therein has a large amount of recording capacity itself, however, it follows that the vehicle driving information recorded in the magnetic disk eventually becomes lost when the HDD becomes damaged due to the accident and becomes unable to perform recording and reproducing.

In contrast, in case of the driving recorder 2 according to the present invention, even when the optical disc apparatus 27 becomes damaged and it becomes unable to perform recording and reproducing, it is possible to take out the optical disc 200 from the inside thereof and reproduce the vehicle driving information by using a different optical disc apparatus, actually by using the optical disc apparatus 30 included in the reproducing apparatus 3 at the company side.

As described above, the buffer memory unit 26 is allocated at a front stage of the optical disc apparatus 27 in order to recover the writing errors due to the vibration. However, in a case where the optical disc apparatus 27 becomes unable to perform writing due to the accident, it follows that the vehicle driving information stored at the inside of the buffer memory unit 26 (that is, vehicle driving information just before it becomes unable to perform writing) is not recorded into the optical disc 200.

Thus, according to the present embodiment, it is formed so as to also perform continuous recording into the flash memory 201, concurrently with recording into the optical disc 200. Hereby, it becomes possible to record the same vehicle driving information as stored in an inside of the buffer memory unit 26, so that the vehicle driving information at the time of an accident can be recorded without any loss, including the vehicle driving information for a period of time just before the optical disc apparatus 27 becomes unable to perform writing.

Here, there will be given a brief explanation of a relation between a recording capacity of the optical disc 200 and a recording time. The explanation will be made for a case, for example, where the driving recorder system 1 is introduced at a taxi company.

As an optical disc 200, as described above, a recordable optical disc 200 is suitable, and, for example, an HD DVD-R is used. In this case, a single layer HD DVD-R has a recording capacity of approximately 15 GB (Byte), and a double layer HD DVD-R has a recording capacity of approximately 30 GB.

Here, there is given an assumption that working hours of a taxi per day are, for example, 12 hours. In a case where it is desired to record all vehicle driving information for 12 hours into a single layer HD DVD-R, a transfer rate of the vehicle driving information may be equal to or less than: 15 GB/(12·60·60) sec.≈350 KB/sec.

In a case where the vehicle driving information includes image data, the image data occupies most of the data amount. Therefore, when recording the image data taken by the in-vehicle video camera into the optical disc 200, it becomes possible to continuously record the image data for 12 hours into the optical disc 200 if a rate of transfer to the optical disc apparatus 27 is equal to or less than approximately 350 KB/sec. Moreover, in a case where a transfer rate of image data outputted from the in-vehicle video camera 100 is greater than approximately 350 KB/sec., a conversion process of the transfer rate may be performed by the optical disc interface unit 25.

When using a double layer HD DVD-R with approximately 30 GB recording capacity, it is possible to enhance the transfer rate to the optical disc apparatus 27 up to approximately 700 KB/sec. In this case, also, it is possible to continuously record the image data for a period of 12 hours into the optical disc 200.

On the other hand, the flash memory 201 is one which compensates for a data loss of the buffer memory unit 26, and a recording capacity thereof is needed to be more than that of the buffer memory unit 26. For example, if an SD card with a recording capacity of 1 GB or so is used as the flash memory 201, it is possible to satisfy this requirement. However, compared with the optical disc 200, it has less recording capacity, so that it is impossible to reach the level of continuous recording for 12 hours. Thus, in the recording of the flash memory 201, the previously stored data is overwritten with the latest data when the recording capacity thereof has reached a full condition.

The optical disc 200 (HD DVD-R), in which the vehicle driving information is recorded, is submitted to a taxi company by a taxi driver as, for example, a daily work record. At the taxi company, the optical disc 200 submitted by the taxi driver is kept as a daily working record, and along with it, it is timely performed to confirm and analyze the operating conditions from the recorded vehicle driving information.

In a case where the driving recorder 2 is not damaged due to an accident or the like, it is enough just to submit the optical disc 200 to the taxi company as a daily work record. In contrast, in a case where an accident or the like occurs and the optical disc apparatus 27 becomes damaged and unable to perform writing, the flash memory 201 is also submitted to the taxi company together with the optical disc 200.

The producing apparatus 3 at the company side is configured so as to include an optical disc apparatus (a second optical disc apparatus) 30, an optical disc interface unit 31, a flash memory reading-out apparatus 32, a flash memory interface unit 33, a decryption apparatus 34 and a display apparatus 36.

Information on the optical disc 200 submitted to the company side is reproduced by the optical disc apparatus 30, and then, the reproduced vehicle driving information is outputted to the decryption apparatus 34 via the optical disc interface unit 31. Moreover, in the same way, information on the flash memory 201 is read out by the flash memory reading-out apparatus 32, and then, the read-out vehicle driving information is outputted to the decryption apparatus 34 via the flash memory interface unit 33.

In the decryption apparatus 34, the vehicle driving information recorded in the optical disc 200 and the vehicle driving information recorded in the flash memory 201 are respectively decrypted (plain texted) by using a secret key 35, and then, the respective pieces of decrypted vehicle driving information are displayed by the display apparatus 36.

The secret key 35 used in the decryption apparatus 34 is an encryption key which becomes a pair with the public key 28. A pair of the private key 35 and the public key 28 is produced by the reproducing apparatus 3 in advance, and the public key 28, one of the pair, is recorded in the optical disc 200 and supplied to the driving recorder 2 mounted in the vehicle. The vehicle driving information encrypted by this public key 28 is recorded into the optical disc 200. The secret key 35, the other one of the pair, remains stored in the reproducing apparatus 3, and the vehicle driving information is decrypted using this secret key 35.

When the public key 28 is distributed to a plurality of vehicles, a plurality of different sets of the secret key 35 and the public key 28 are produced, and then, the sets are individually allocated to vehicles or drivers. At this time, by allocating a set, which is randomly selected from the plurality of sets, to a vehicle or a driver, it becomes more difficult for the driver to identify the secret key 35 from the public key 28, so that it becomes effective in preventing a fraud, such as a falsification, relating to the vehicle driving information. Moreover, if a specific identification information (ID) is allocated to the driving recorder 2 and it is made so as to record the identification information into the optical disc 200, being included in the vehicle driving information, identification of a correspondence relation between the optical disc 200 and the driving recorder 2 is possible, so that it becomes more useful in the prevention of fraud.

### (2) A Recording and Reproducing Method of the Driving Recorder System 1

An explanation of details of a recording and reproducing method for the driving recorder system 1 which is configured as described above will be given.

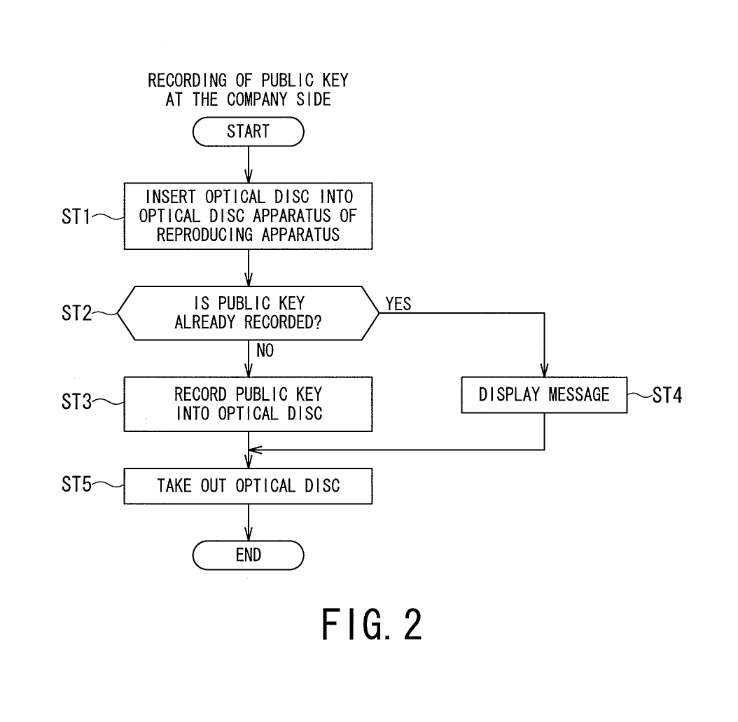

FIG. 2 is a flowchart showing an example of a sequence for recording the public key 28 into the optical disc 200 involving the reproducing apparatus 3 at the company side.

First, a blank optical disc 200 (for example, an HD DVD-R) is inserted into the optical disc apparatus 30 of the reproducing apparatus 3 (step ST1).

The optical disc apparatus 30 reproduces the optical disc 200, and determines whether the public key 28 is already recorded or not (step ST2). When the public key 28 is already recorded, it is highly likely that the inserted optical disc 200 is not actually a blank one, so that a message representing the result thereof is displayed by the display apparatus 36 (step ST4).

On the other hand, when the public key 28 is not recorded, a set of the secret key 35 and the public key 28 is produced, and the public key 28 is recorded into the optical disc 200 (step ST3). The private key 35 remains stored in an appropriate storage apparatus (not shown in the figure) inside the reproducing apparatus 3.

Finally, the optical disc 200, in which the public key 28 is recorded, is taken out from the optical disc apparatus 30 (step ST5). In this optical disc 200, only the public key 28 is recorded in a prescribed area, and the other areas are in a blank condition. This optical disc 200 is transferred to a driver.

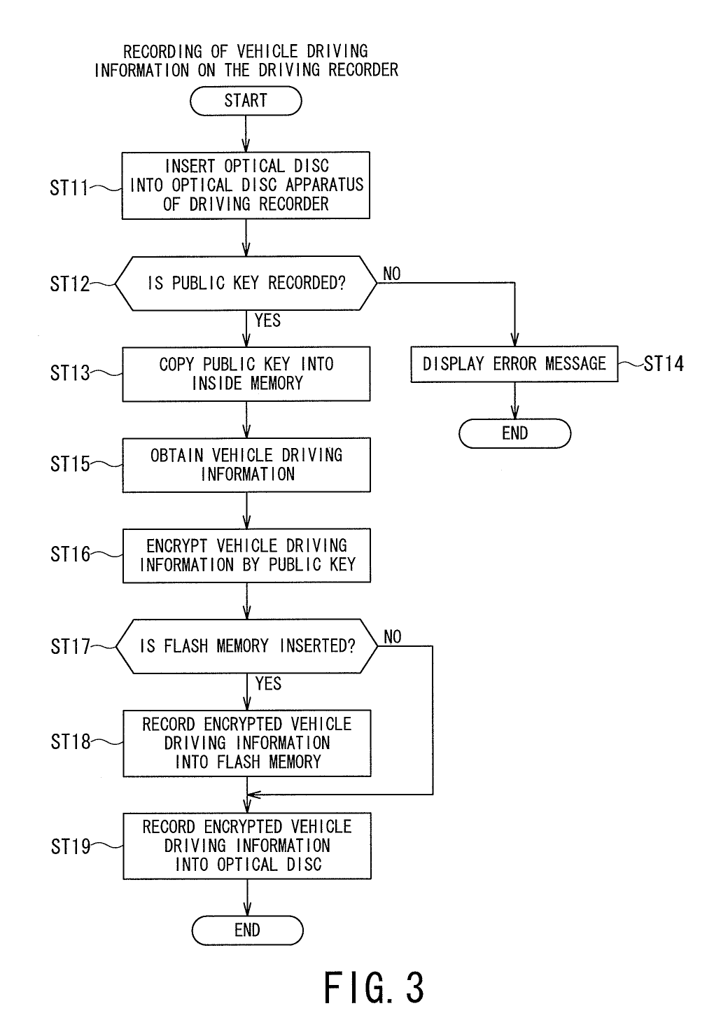

FIG. 3 is a flowchart showing an example of a sequence for recording the vehicle driving information involving the driving recorder 2.

The driver inserts the transferred optical disc 200 into the optical disc apparatus 27 of the driving recorder 2 (step ST11). The optical disc apparatus 27 reproduces the optical disc 200, and determines whether the public key 28 is recorded or not (step ST12). When the public key is not recorded, an error message representing the result thereof is displayed at an appropriate display apparatus (not shown in the figure) (step ST14).

On the other hand, when the public key 28 is recorded, the public key 28 is read out and copied into an appropriate memory inside the driving recorder 2 (step ST13). At this stage, it becomes possible for the driving recorder 2 to perform recording and the vehicle driving information is obtained from the in-vehicle video camera 100 and vehicle sensor 101 (step ST15). These pieces of vehicle driving information are multiplexed in the data combining unit 21, and then, encrypted in the encryption apparatus 22 by using the public key 28 (step ST16). Here, it is determined whether the flash memory 201 is inserted or not (step ST17), and when the flash memory 201 is not inserted, the encrypted vehicle driving information is recorded only into the optical disc 200 (step ST19). When the flash memory 201 is inserted, the encrypted driving information is also recorded into the flash memory 201.

In addition, when the public key 28 is not recorded, it is also allowed to omit the encrypting step and perform recording into the optical disc 200 as it is in plain text. In this case, however, a risk of leaking the vehicle driving information recorded in the optical disc 200 to a third party becomes higher.

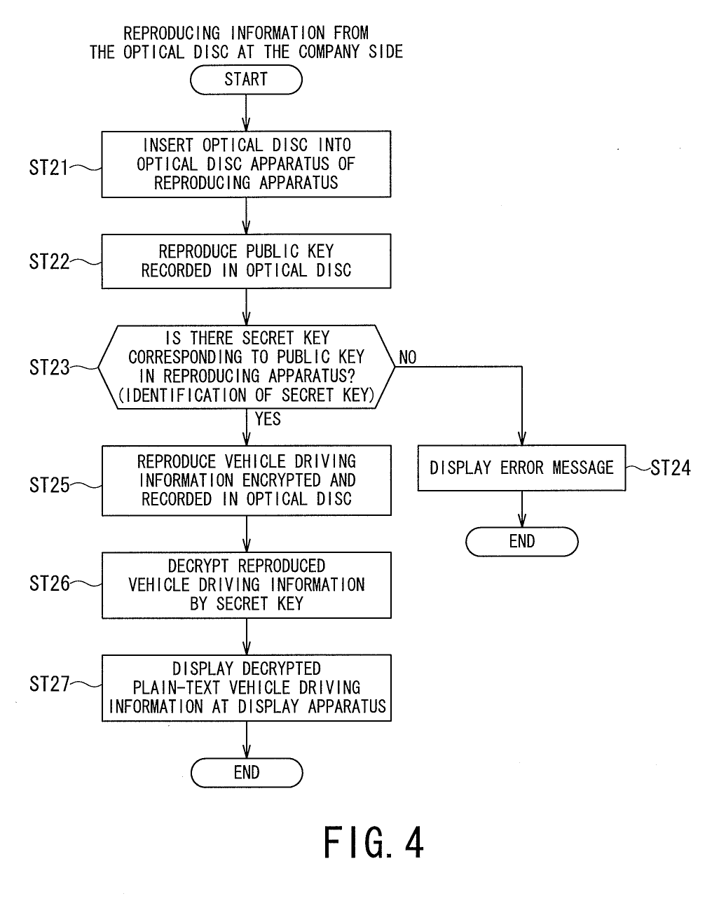

FIG. 4 is a flowchart showing an example of a sequence for reproducing information from the optical disc 200, which is recorded in the driving recorder 2, involving the reproducing apparatus 3 at the company side.

First, the optical disc 200 received from the driver is inserted into the optical disc apparatus 30 of the reproducing apparatus 3 (step ST21). The optical disc apparatus 30, firstly, reproduces the public key 28 recorded in the optical disc 200 (step ST22). Subsequently, it is determined whether a secret key 35 corresponding to the public key 28 is stored or not, and then, the secret key 35 corresponding to the public key 28 is identified (step ST23).

When the corresponded secret key 35 cannot be identified, an error message representing the result thereof is displayed at the display apparatus 36, and then, the optical disc 200 is taken out from the optical disc apparatus 30 and the process is terminated (step ST24).

When the secret key 35 can be identified, the vehicle driving information recorded in the optical disc 200 is reproduced (step ST25). After that, the reproduced vehicle driving information is decrypted (plain-texted) by using the secret key 35 (step ST26). The decrypted vehicle driving information is displayed by the display apparatus 35, and then, the process is terminated (step ST27).

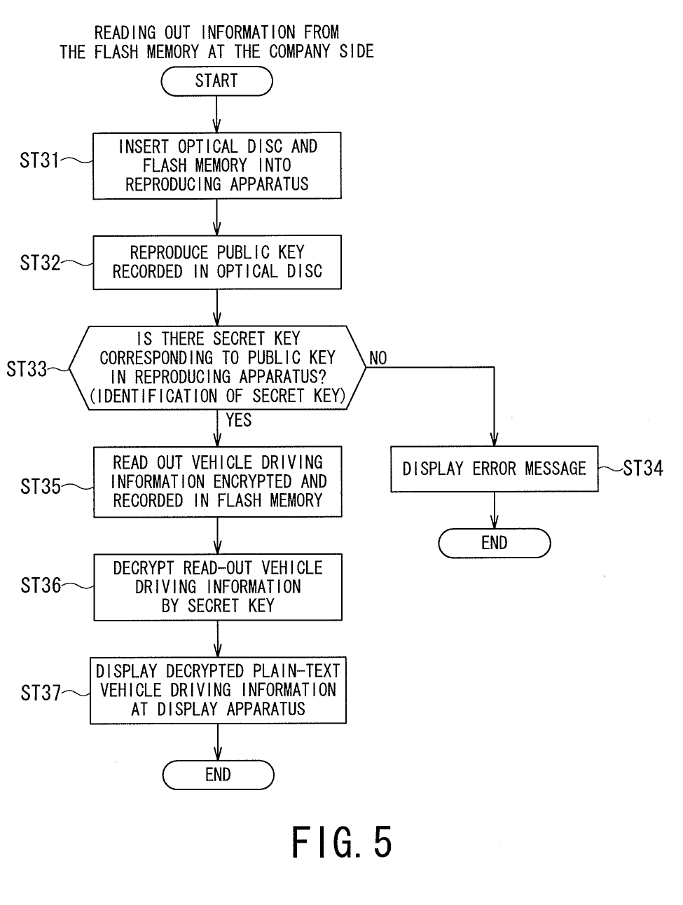

FIG. 5 is a flowchart showing an example of a sequence for reading out information from the flash memory 201, which is recorded in the driving recorder 2, involving the reproducing apparatus 3 at the company side.

First, the flash memory 201 and the optical disc 200 received from the driver are inserted into the optical disc apparatus 30 (step ST31). Since the vehicle driving information recorded in the flash memory 201 is also encrypted by the public key 28, it is needed to identify a secret key 35 corresponding to the public key 28. A process for this is composed of steps from the step ST32 to the step ST34, and is performed in the same steps as ones from the step ST22 to the step ST24 in the FIG. 4.

Once the secret key 35 is identified (in case of YES at the step ST33), the vehicle driving information encrypted and recorded in the flash memory 201 is read out (step ST35). After that, the read-out vehicle driving information is decrypted using the secret key 35 (step ST36). The decrypted vehicle driving information is displayed by the display apparatus 36, and then, the process is terminated.

As explained above, according to the present embodiment, since the vehicle driving information of the driving recorder 2 is recorded into the optical disc 200, it is possible to take out only the optical disc 200 and reproduce it using the reproducing apparatus 3 even when the optical disc apparatus 27 becomes damaged due to an accident. Moreover, there is no case of losing the vehicle driving information for a period of time just before the optical disc apparatus 27 becomes damaged.

Since the optical disc 200 itself is low in cost, an operation of recording the vehicle driving information into a recordable optical disc 200 and storing the recording-completed optical disc 200 in series is possible. Accordingly, it becomes unnecessary to perform an operation of transferring the recorded data to other recording media, as is observed in case of a driving recorder having only the flash memory 201 mounted therein, or a driving recorder having the HDD mounted therein, so that a work load associated with the handling of recorded data is reduced. Moreover, since the vehicle driving information is recorded into, not a rewritable recording medium, but the recordable optical disc 200 capable of recording information therein only once, it is possible to avoid falsification made by rewriting data stored in a same medium.

Furthermore, since encrypted vehicle driving information is recorded in the optical disc 200, there is no danger of leaking of recorded data even when the optical disc 200 is transferred to a third party. Moreover, since the public key 28 is recorded in the optical disc 200 itself, a recording medium for recording the vehicle driving information and the public key 28 always move as one unit, so that it becomes simpler to handle the public key 28, compared with a form of obtaining the public key 28 via a different route. Moreover, when updating the public key 28 with an aim of enhancing confidentiality and so forth, it is enough just to record a new public key 28 into an optical disc 200 distributed from a company, and thus, it is possible to update the public key 28 more efficiently, compared with a method of storing the public key 28 in the driving recorder 2 in advance.

As described above, according to the driving recorder, the driving recorder system and the recording and reproducing method for driving recorder system in accordance with the present embodiment, it is possible to realize high security with no superfluous operations, along with easy-to-use handling of recorded data and excellent impact resistance.

Additionally, it should be noted that the present invention is not limited to the above-described embodiment as it is, but, at an implementation stage, modifications are permissible to the extent that they do not deviate from the scope of the invention. Moreover, it is possible to form various forms of the invention by appropriately composing a plurality of constituents disclosed in the above-described embodiment. For example, some constituents may be deleted from all the constituents shown in the embodiment. Furthermore, constituents across different embodiments may be appropriately composed.

What is claimed is:

1. A driving recorder, comprising:
an encryption apparatus configured to encrypt vehicle driving information using a public key; and
an optical disc apparatus configured to continuously record the encrypted vehicle driving information onto an optical disc,
wherein the public key is pre-recorded to the optical disc.

2. The driving recorder according to claim 1, further comprising a memory recording apparatus for configured to continuously record the vehicle driving information to a nonvolatile memory in conjunction with recording of the vehicle driving information onto the optical disc.

3. The driving recorder according to claim 1, wherein the optical disc is a write-once optical disc.

4. A driving recorder system, comprising:
a driving recorder for recording vehicle driving information; and
a reproducing apparatus for reproducing the vehicle driving information recorded in the driving recorder,
wherein the driving recorder comprises an encryption apparatus configured to encrypt the vehicle driving information using a public key, and a first optical disc apparatus configured to continuously record the vehicle driving information onto an optical disc,
wherein the reproducing apparatus comprises a second optical disc apparatus configured to reproduce the vehicle driving information recorded onto the optical disc, and a decryption apparatus configured to decrypt the vehicle driving information reproduced thereby using a secret key corresponding to the public key, and
wherein the public key is pre-recorded to the optical disc.

5. The driving recorder system according to claim 4, wherein the driving recorder further comprises a memory recording apparatus configured to continuously record the vehicle driving information to a nonvolatile memory in conjunction with recording of the vehicle driving information onto the optical disc, and wherein the reproducing apparatus further comprises a memory reproducing apparatus configured to reproduce the vehicle driving information recorded to the nonvolatile memory.

6. The driving recorder system according to claim 4, wherein the optical disc is a write-once optical disc.

7. A recording and reproducing method for a driving recorder system, comprising the steps of:
encrypting vehicle driving information using a public key;
continuously recording the vehicle driving information onto an optical disc;
reproducing the vehicle driving information recorded onto the optical disc; and
decrypting the vehicle driving information using a secret key corresponding to the public key,
wherein the encryption is performed using a public key pre-recorded onto the optical disc.

8. The recording and reproducing method according to claim 7, further comprising the steps of:
continuously recording the vehicle driving information to a nonvolatile memory in conjunction with recording of the vehicle driving information onto the optical disc; and
reproducing the vehicle driving information recorded in the nonvolatile memory.

9. The recording and reproducing method according to claim 7, wherein the optical disc is a write-once optical disc.
